(19) United States
(12) Patent Application Publication
(10) Pub. No.: US 2014/0293644 A1
(43) Pub. Date: Oct. 2, 2014

(54) ILLUMINATION DEVICE

(71) Applicant: ACME PLASTICS, INC., Woodland Park, NJ (US)

(72) Inventor: Larry Levinson, Livingston, NJ (US)

(73) Assignee: Acme Plastics, Inc., Woodland Park, NJ (US)

(21) Appl. No.: 13/852,838

(22) Filed: Mar. 28, 2013

(51) Int. Cl. G09F 13/18

(52) U.S. Cl. CPC G09F 13/18
USPC 362/604

(57) ABSTRACT

A point of purchase display unit with a light-conducting plastic support base and a plurality of sides. The support base is shaped to substantially conform to a translucent article, preferably fabric and most preferably comprising an article of clothing, stretched over at least a portion of the surface of the support base. In another embodiment, the article may comprise a translucent bottle. A plurality of light sources, preferably LED's positioned along at least a portion of the perimeter of the support base is utilized to transmit light through the support base in order to illuminate the fabric or article, thereby enhancing its visibility.

### FIELD OF THE INVENTION

The present invention relates in general to point-of-purchase displays and in particular to a device intended to illuminate translucent material such as clothing in order to draw consumer attention to the clothing for the purpose of inducing clothing sales.

### BACKGROUND OF THE INVENTION

Merchandisers have long sought to find novel ways to attract consumer attention to their products. In particular, manikins are commonly used to depict clothing on a human-like form. Often, manikins are used in store display windows or sales floors in order to attract consumer attention. Unfortunately, manikins take up valuable floor space and do not always focus a consumer's attention on a particular garment. Alternatively, marketing experts commonly use enlarged photo images of clothing or other two-dimensional displays. However, these large images take up considerable floor area and are expensive to produce. Additionally, large photo images are not easily redesigned and redisplayed to highlight a rapidly changing product line.

There therefore exists a need in the art to develop inexpensive novel point-of-purchase displays to attract consumer attention to translucent materials such as articles of clothing that will not occupy considerable floor area or fail to draw consumer attention to particular articles of clothing. There is a further need in the art to develop a means for marketing translucent materials such as articles of clothing that is versatile enough to easily adapt to various articles of clothing in a rapidly changing product line. There is a further need to develop point-of-purchase displays that possess an inexpensive illumination light source that will attract consumer attention from a distance to such displays such as for clothing and perfume bottles.

### SUMMARY OF THE INVENTION

According to the present invention, the foregoing and other objects and advantages are obtained by a point of purchase display unit comprising a light-conducting support base preferably of a plastic material consisting of a top, bottom, and sides defining a top, bottom and side surfaces. The support base is shaped to substantially conform to translucent materials such as fabric located in front of or stretched over at least a portion of the surface of the support base. In one embodiment of the invention, a plurality of light sources are positioned about at least a portion of the perimeter of the support base, whereby the light from the light sources is transmitted throughout the support base and through the translucent fabric, thereby enhancing the visibility of the fabric.

According to another aspect of the invention, the plastic is selected from the group consisting of acrylics, polycarbonate and PETG-based polymers.

According to another aspect of the invention, the display unit is plastic and the plastic is translucent.

According to another aspect of the invention, the display unit is plastic and the plastic is transparent.

According to another aspect of the invention, the plastic is an acrylic-based polymer and contains colorless light-diffusing particles embedded therein that cause light emanating from a light source positioned along at least a portion of the perimeter of the support base to diffuse throughout the plastic.

According to another aspect of the invention, the light sources are selected from the group consisting of florescent tubes, cold cathode fluorescents, neon and LED's.

According to another aspect of the invention, the light source consists of a plurality of LED lights integrated into a u-channel-shaped snap-on shaped to releaseably fit over at least a portion of the perimeter of the support base.

According to another aspect of the invention, the light source consists of a plurality of LED lights integrated into an adhesive strip which adheres to at least a portion of the perimeter of the support base.

According to another aspect of the invention, the light source is embedded into the surface of the support base and situated along at least a portion of the perimeter of the support base.

According to another aspect of the invention, the translucent material is fabric and comprises an article of clothing.

According to another aspect of the invention, the article of clothing comprises panties or a tank top.

According to another aspect of the invention, the translucent material comprises a bottle.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a perspective view of a support base with an illumination source according to one embodiment of the invention;

FIG. 2 is a perspective bottom view of a u-channel-shaped snap-on light source according to one embodiment of the invention;

FIG. 2A is a perspective side view of the u-channel-shaped snap-on.

FIG. 2B is a side view of the u-channel-shaped snap-on positioned over the top side of the support base.

FIG. 3 is a perspective view of underwear positioned on a plastic support base according to one embodiment of the invention; and

FIG. 4 is a perspective view of a tank top positioned on an illuminated plastic support base according to one embodiment of the invention.

FIG. 5 is a perspective view of a support base with LED lights embedded.

FIG. 6 is a perspective view of the support base with a cold cathode fluorescent tube as the light source.

FIG. 7 is a perspective view of the support base with a perfume bottle positioned thereupon according to one embodiment of the invention.

### DETAILED DESCRIPTION OF THE INVENTION

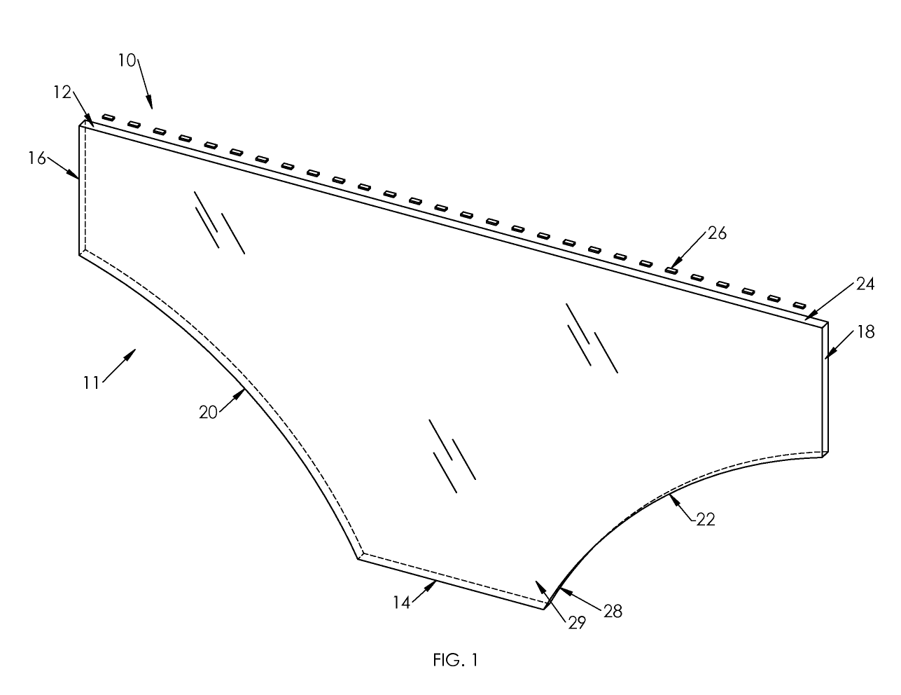

Referring to the drawings wherein like or similar references indicate like or similar elements throughout the several views, there is shown in FIG. 1 a perspective view of an illumination device according to one embodiment of the invention, generally identified by reference numeral 10.

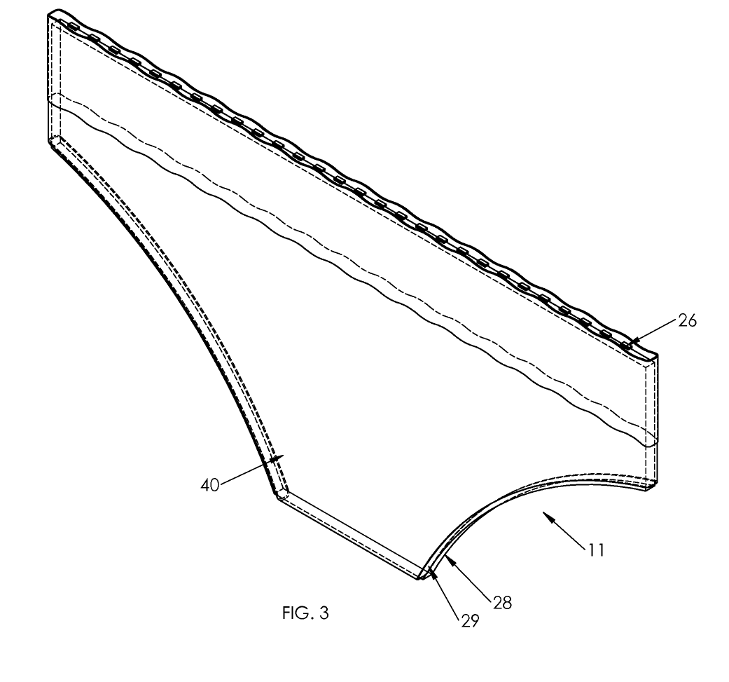

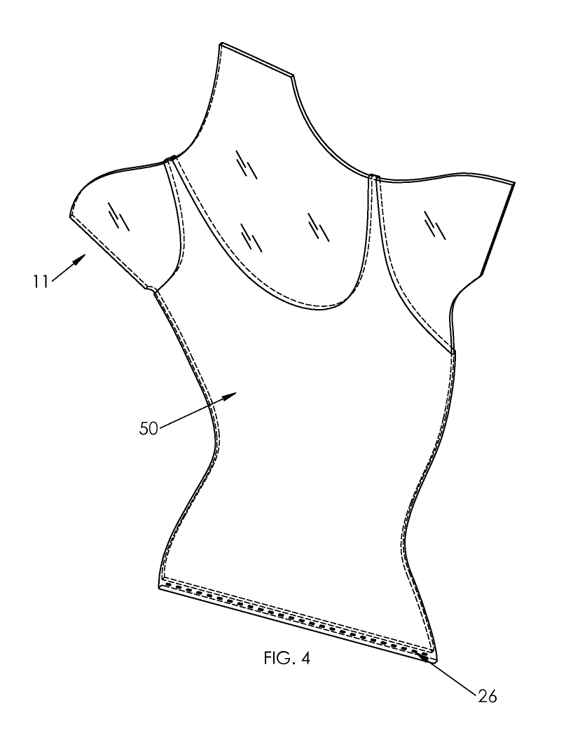

FIG. 1 depicts a light-conducting support base 11, preferably plastic, consisting of a top side 12, bottom side 14, and side surfaces 16, 18, 20, 22 and 24. The interior surface of the support base, 11, is depicted as 28 and the outer surface is depicted as 29. The light conducting plastic support base 11 can be constructed from acrylics, polycarbonates, PETG-based polymers, or any other translucent or transparent solid plastic material known to those having skill in the art. In other embodiments, such as the plastic support base depicted in FIGS. 3 and 4, the plastic support base can take the form of any other shape. Those skilled in the art will recognize the benefit of adapting the shape of a support base to conform to the general outline of an article of clothing positioned thereon such as shown in FIGS. 3 and 4. In other embodiments any other material may be used to fabricate the support base so long as it transmits light.

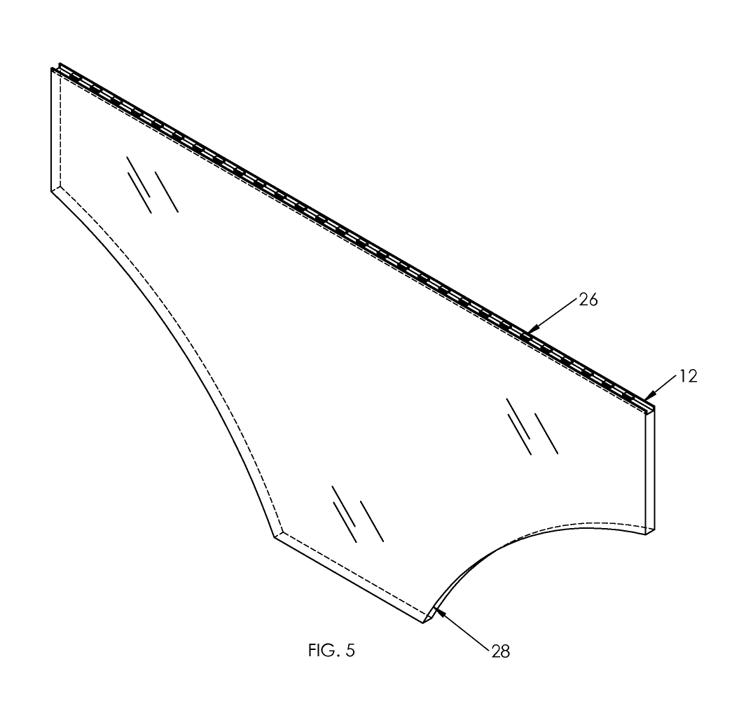

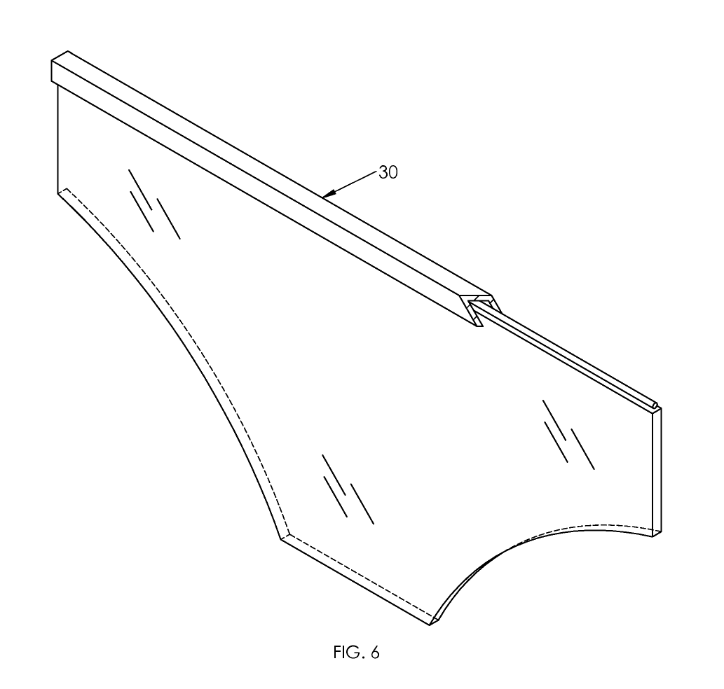

In one embodiment of the invention, depicted in FIG. 1, the light conducting plastic support base 11 includes an array of LED lights 26 located along a portion of surface 24 of the plastic support base 11. In another embodiment, FIG. 5, LED lights 26 are embedded into the interior volume of the plastic support base 11 along the top side 12. In other embodiments of the invention, the light sources may be florescent tubes, cold cathode fluorescents (see FIG. 6), or neon lights (not depicted).

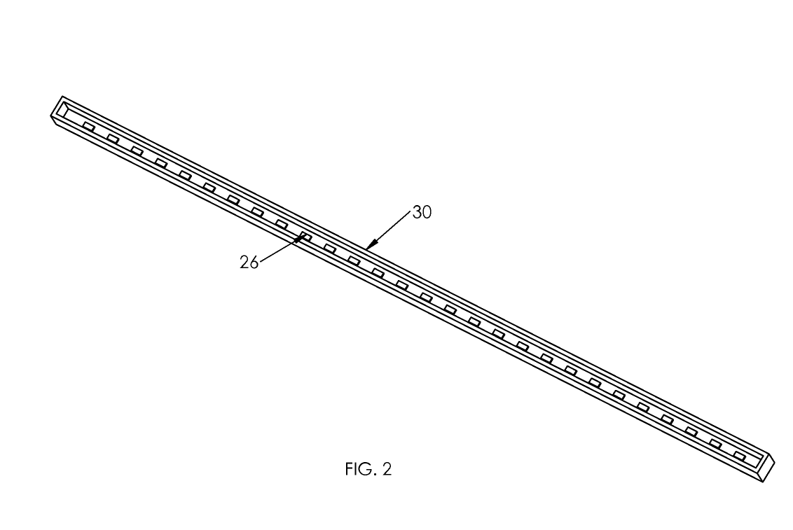

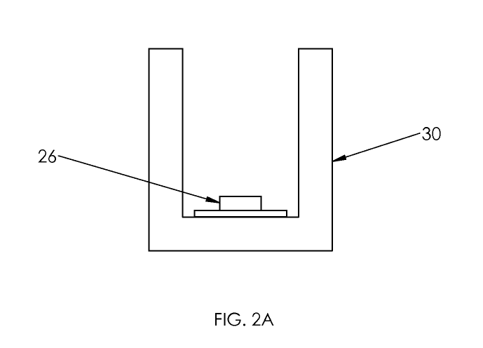

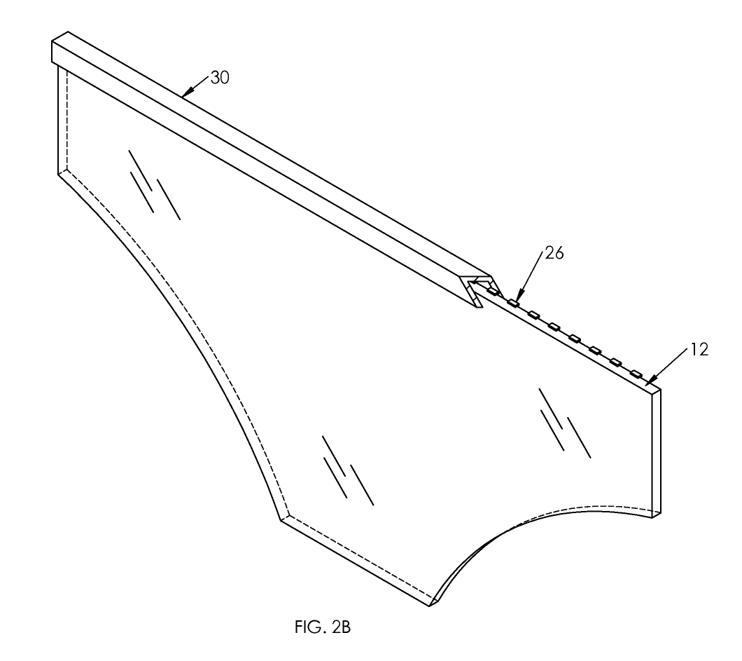

In another embodiment of the invention, depicted in FIG. 2, the light source consists of a plurality of LED lights integrated into a u-channel-shaped snap-on 30 shaped to releasably fit over at least a portion of the perimeter of the plastic support base 11. In FIG. 2A, a side view of the snap-on, 30, shows the u-shaped configuration with the LED's, 26, secured therein. In FIG. 2B, the snap-on, 30, is shown positioned at top edge, 12.

FIG. 3 depicts an article of underwear 40 (panties) stretched over the exterior surface of the plastic support base 11. Light emanating from the LED light source 26 (FIG. 1) is transmitted throughout the interior surface, 28, of the plastic support base 11 and is further transmitted from the outer surface, 29, of the plastic support base 11 through the translucent underwear 40 fabric. In so doing, underwear 40 is brightly illuminated, thereby enhancing its visibility, particularly at a distance.

In another embodiment, the garment may be fashioned into a tank top 50, as depicted on FIG. 4. In this embodiment the support base comprises the upper torso of a manikin. In other embodiments, the fabric may be fashioned into any other article of clothing with sufficient translucency to permit light to illuminate the article in the manner herein described.

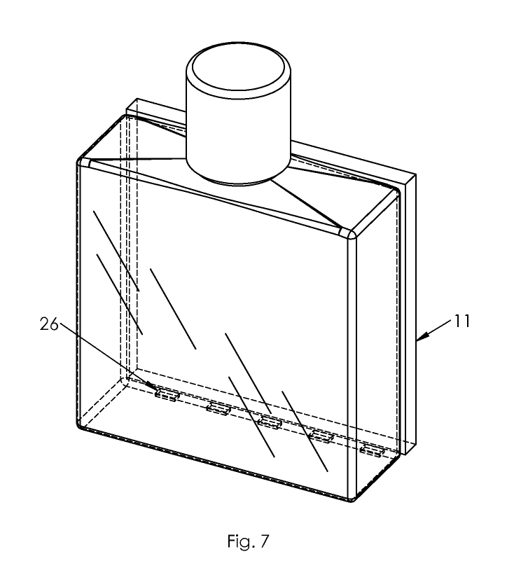

In another embodiment, the support base can be used to illuminate non-clothing translucent materials with sufficient translucency to permit light to illuminate the article in the manner herein described. For example, such embodiments may include a container such as a translucent or transparent plastic or glass bottle, e.g. a perfume bottle. As shown in FIG. 7, the support base holds a perfume bottle that conforms to the shape of the support base.

In one embodiment, the support base 11 is comprised of an acrylic-based polymer and contains colorless light-diffusing particles embedded therein that cause light emanating from a light source positioned about at least a portion of the perimeter of the plastic support base 11 to diffuse light throughout the plastic support base 11. Such particles may include inorganic particles, such as glass beads, titanium oxide particles, particles made of styrene resin, acrylic resin, silicone resin, or other particles known to those having skill in the art for the purpose of reflecting light throughout the interior volume of the plastic support base 11. This polymer is well known in the art and is manufactured by Evonik Industries under the name Acrylite®.

In another embodiment, the support base 11 may be curved around the contour of a manikin or otherwise shaped in three dimensions (not depicted) for the purpose of displaying articles of clothing in an anatomically correct fitting.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A point of purchase display unit comprising:
a light-conducting support base consisting of top, bottom and sides defining top, bottom and side surfaces, said support base shaped to substantially conform to translucent material situated over at least a portion of the surfaces of said support base; and
a plurality of light sources positioned along at least a portion of the perimeter of the support base, whereby the light from the light sources is transmitted throughout the support base and through the translucent material, thereby enhancing the visibility of the translucent material.

2. The point-of-purchase display unit of claim 1 wherein the support base is plastic and the plastic is selected from the group consisting of: acrylics, polycarbonate and PETG-based polymers.

3. The point-of-purchase display unit of claim 1 wherein the support base is plastic and the plastic is translucent.

4. The point-of-purchase display unit of claim 1 wherein the support base is plastic and the plastic is transparent.

5. The point-of-purchase display unit of claim 1 wherein the support base is plastic and the plastic is an acrylic-based polymer and contains colorless light-diffusing particles embedded therein that cause light emanating from a light source positioned about at least a portion of the perimeter of the support base to diffuse throughout the plastic.

6. The point-of-purchase display unit of claim 1 wherein the light sources are selected from the group consisting of: florescent tubes, cold cathode fluorescents, neon and LED's.

7. The point-of-purchase display unit of claim 1 wherein the light source consists of a plurality of LED lights integrated into a u-channel-shaped snap-on shaped to releaseably fit over at least a portion of the perimeter of the support base.

8. The point-of-purchase display unit of claim 1 wherein the light source consists of a plurality of LED lights integrated into an adhesive strip which adheres to at least a portion of the perimeter of the support base.

9. The point-of-purchase display unit of claim 1 wherein the light source is embedded into the surface of the support base and situated along at least a portion of the perimeter of the support base.

10. The point-of-purchase display unit of claim 1 wherein the translucent material comprises an article of clothing.

11. The point-of-purchase display unit of claim 10 wherein the article of clothing of claim 10 comprises panties.

12. The point-of-purchase display unit of claim 10 wherein the article of clothing of claim 10 comprises a tank top.

13. The point-of-purchase display unit of claim 1 wherein the translucent material comprises a shampoo bottle.

14. The point-of-purchase display unit of claim 1 wherein the translucent material comprises a perfume bottle.
